(19) United States
(12) Patent Application Publication
(10) Pub. No.: US 2017/0320105 A1
(43) Pub. Date: Nov. 9, 2017

(54) PAPER PRODUCT

(71) Applicants: Jacklin Roozrokh, Hauppauge, NY (US); Shahram Roozrokh, Hauppauge, NY (US)

(72) Inventors: Jacklin Roozrokh, Hauppauge, NY (US); Shahram Roozrokh, Hauppauge, NY (US)

(73) Assignee: Select Products Holdings LLC, Huntington, NY (US)

(21) Appl. No.: 15/145,290

(22) Filed: May 3, 2016

(51) Int. Cl. B08B 1/00; B32B 5/02

(52) U.S. Cl. CPC B08B 1/006; B32B 5/022; B32B 2305/20

(57) ABSTRACT

The present disclosure is directed to a nonwoven product and methods of making the same. The nonwoven product includes a nonwoven material formed of a fibrous material, the nonwoven material comprising one or more plies, the nonwoven material comprising a first side, a second side, a cross direction and a machine direction, wherein the cross direction is substantially perpendicular to the machine direction, the nonwoven material comprising a number of perforations extending substantially in the cross direction and substantially in the machine direction, wherein the number of perforations extending substantially in the machine direction form a first section of the nonwoven material, the first section comprising a soap material.

### BACKGROUND OF THE DISCLOSURE

It has been known that perforation of products manufactured from nonwoven webs, such as paper towels, toilet tissues and the like has occurred to facilitate removal of sheets from a roll by tearing.

Also, it has been known that such conventional nonwoven materials can include a soap or other product impregnated across the entire length and width of each sheet of material.

What is desired is a product that includes perforations in a direction perpendicular to the length of the roll and parallel with the length of the roll. What is also desired is a product that includes a section that includes a soap in one region of the product, not the entire region of the product. Therefore, what is desired is a product that includes a soap or other material in one section of a sheet of material, and allows for removal of that section of material from the remaining material of the sheet.

Embodiments of the present disclosure provide structures and methods that address the above and other issues.

### SUMMARY OF THE DISCLOSURE

The present disclosure is directed to a nonwoven product and methods of making the same. The nonwoven product includes a nonwoven material formed of a fibrous material, the nonwoven material comprising one or more plies, the nonwoven material comprising a first side, a second side, a cross direction and a machine direction, wherein the cross direction is substantially perpendicular to the machine direction, the nonwoven material comprising a number of perforations extending substantially in the cross direction and substantially in the machine direction, wherein the number of perforations extending substantially in the machine direction form a first section of the nonwoven material, the first section comprising a soap material.

### BRIEF DESCRIPTION OF THE DRAWINGS

The present disclosure will be better understood by reference to the following drawings of which:

FIG. 1 is an illustration of a nonwoven product;

FIG.2 is an illustration of a roll of nonwoven product;

FIG.3 is a perspective view of a perforating apparatus;

FIG.4 is a perspective view of a perforator;

FIG. 5 is a perspective view of a soap applicator;

FIG. 6 is a perspective view of a fountain reservoir; and

FIG. 7 is a perspective view of the soap applicator.

### DETAILED DESCRIPTION OF THE DISCLOSURE

As used herein, the term “about” indicates that the value listed may be somewhat altered, as long as the alteration does not result in nonconformance of the process or structure to the illustrated embodiment. For example, for some elements the term “about” can refer to a variation of ±0.1%, for other elements, the term “about” can refer to a variation of ±1% or ±10%, or any point therein.

As used herein, the term “substantially” refers to the complete or nearly complete extent or degree of an action, characteristic, property, state, structure, item, or result. For example, an object that is “substantially” parallel would mean that the object is either completely parallel or nearly completely parallel. The exact allowable degree of deviation from absolute completeness may in some cases depend on the specific context. However, generally speaking the nearness of completion will be so as to have the same overall result as if absolute and total completion were obtained.

As used herein, the term “machine direction” means substantially the direction of travel of a nonwoven product through any processing equipment. As used herein, the term “cross direction” means a direction that is substantially perpendicular to the machine direction.

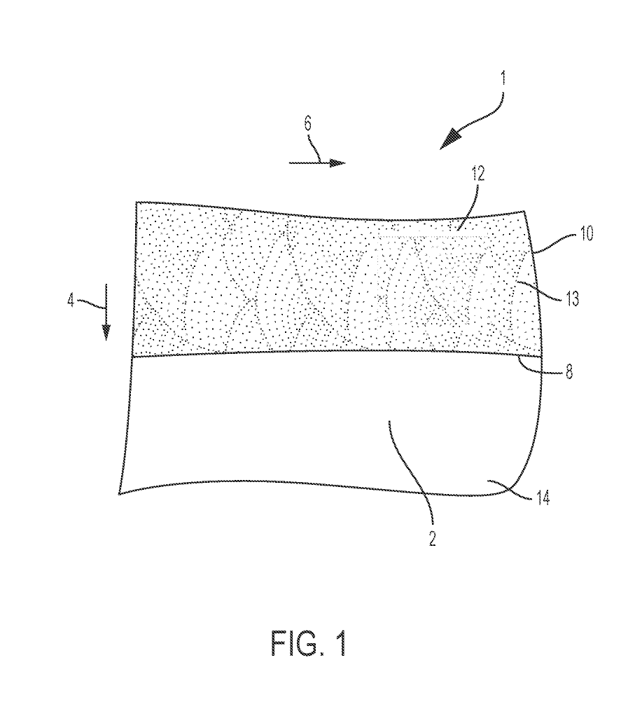

As seen in FIG. 1, a nonwoven product 1 is illustrated. Nonwoven product 1 can be any nonwoven material composed of a conglomeration of fibrous materials and additives. Nonwoven products may be wet-formed materials or dry-formed materials. Wet-formed materials are those materials formed from an aqueous or predominantly aqueous suspension of synthetic fibers or natural fibers, such as vegetable, mineral, animal, or combinations thereof by draining the suspension and drying the resulting mass of fibers; and dry-formed materials are those materials formed by other means such as air-laying, carding or spinbonding without first forming an aqueous suspension. Nonwoven materials may further include composites of wet and dry formed materials where the composite is formed by means such as hydroentangling or laminating.

The nonwoven product 1 can be comprised of one or more plies of the fibrous material depending upon the desired use. As shown in FIG. 1, nonwoven product 1 includes a first side 2, a second side (not shown), which opposes the first side, a cross direction 4 and a machine direction 6. The cross direction 4 is substantially perpendicular to the machine direction 6.

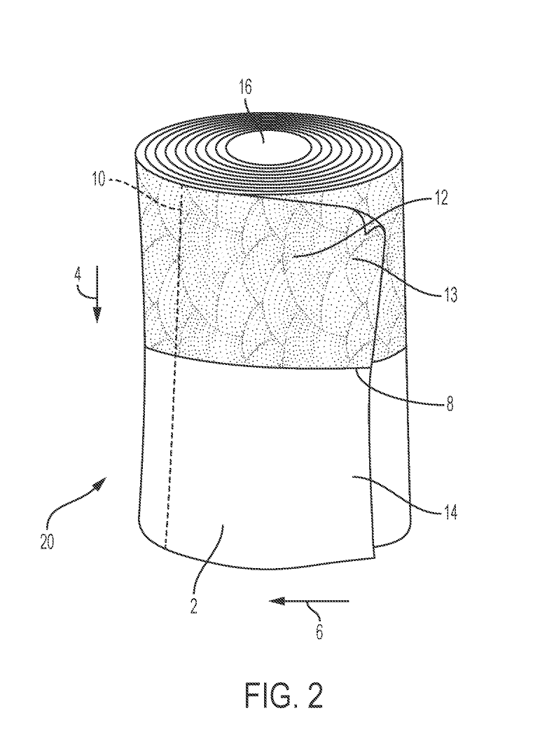

The nonwoven product 1 of FIG. 1 is a single sheet of product for illustrative purposes. Nonwoven product 1 can be formed as part of a roll, as shown in FIG. 2 and discussed below. Referring again to FIG. 1, the nonwoven material of nonwoven product 1 includes a number of cross direction perforations 10 extending in the cross direction 4 and a number of machine direction perforations 8 extending in the machine direction 6. Each number of perforations in the machine direction 6 and in the cross direction 4 can include a line of perforations, or a number of lines of perforations, in any suitable pattern or configuration. The perforations can be in a slit shape or pin hole shape.

The machine direction perforations 8 are formed between a first section 12 of nonwoven product 1 and a second section 14 of nonwoven product 1. In this embodiment, first section 12 comprises a soap material 13 that is added to the nonwoven material. As shown in FIG. 1 first section 12 is of about equal area as second section 14, but, in other embodiments first section 12 can be any suitable percentage, less than 100%, of the area of nonwoven product 1, with the second section 14 being the remainder of the area of nonwoven product 1.

As used herein, the term “soap” includes any water-soluble salt of fatty acids that contain about 8 or more carbon atoms. In an exemplary embodiment of the present disclosure, the soap can comprises at least one of sodium tallowate, sodium palmitate, sodium stearate and sodium palm kernelate, salts of fatty acids having alkyl chain lengths with 12 to 18 carbons. The soap, however, can include other fats and oils from which soaps may be produced, such as babassu oil, soybean oil, cottonseed oil, rapeseed oil or other comparable vegetable product, whale or fish oils and lards, and the like. Various other animal fats and oils may also be employed to produce soaps similar to soaps mentioned above.

In one embodiment the soap can be composed of (a) Sulfuric acid, C10-16-alkyl ester, sodium salt, having a CAS number of 68585-47-7, at about 15% to about 20% by volume; (b) amine oxide, C10-16-alkyldimethyl, having a CAS number of 70592-80-2, at about 5% to about 10% by volume; (c) poly(oxy-1,2-ethanediyl),alpha-sulfo-omega-hydroxy-C10-16-alkyl ether, sodium salt, having a CAS number of 68585-34-2, at about 5% to about 10% by volume; (d) with the balance of the volume of the soap being water.

As shown in FIG. 2, a length of nonwoven product can be formed into a roll 20, with first side 2 exposed to the exterior of the roll. The roll 20 can be formed around a central tube 16, which can be substantially circular.

To form the roll of FIG. 2, a full length of nonwoven product of desired width and length is acquired. That full sheet undergoes at least three operations, in any desired order, which are (1) perforations are applied in the machine direction 6, (2) perforations are applied in the cross direction 4, and (3) soap is applied to the first section 12. These operations are discussed in order from (1) to (3) below, but this is for illustrative purposes only.

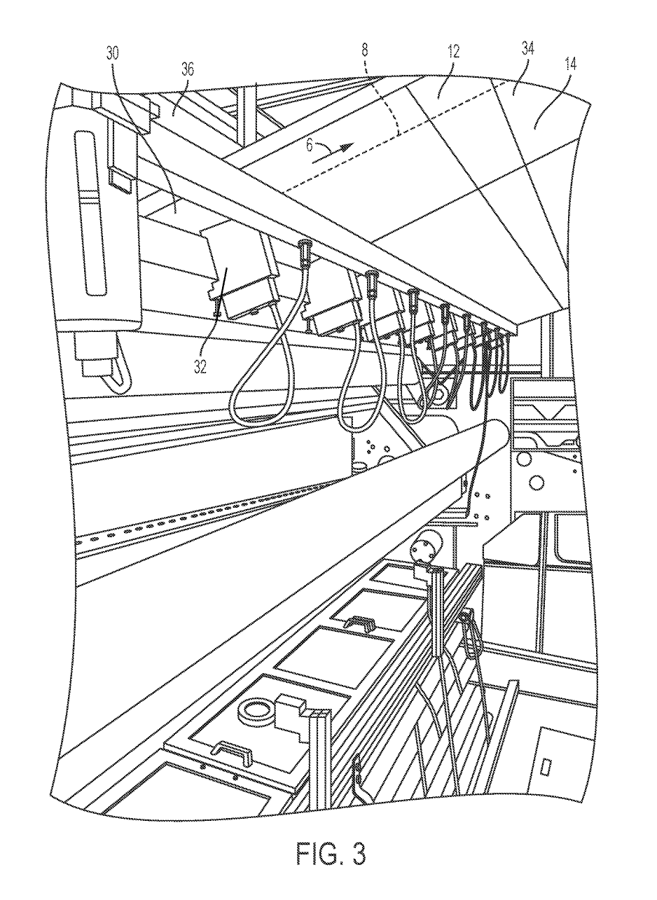

For providing perforations in the machine direction 6, a length of machine direction unperforated nonwoven product 30 is fed through an apparatus in a machine direction 6, as shown in FIG. 3. Prior to perforation, the machine direction unperforated length of nonwoven product 30 passes a perforator 32 and a roller 36. The perforator 32 applies machine direction perforations 8 of any suitable configuration and size. Once past the perforator 32, a machine direction perforated length of nonwoven product 34 is formed. This machine direction perforated length of nonwoven product 34 includes machine direction perforations 8, separating a first section 12 from a second section 14.

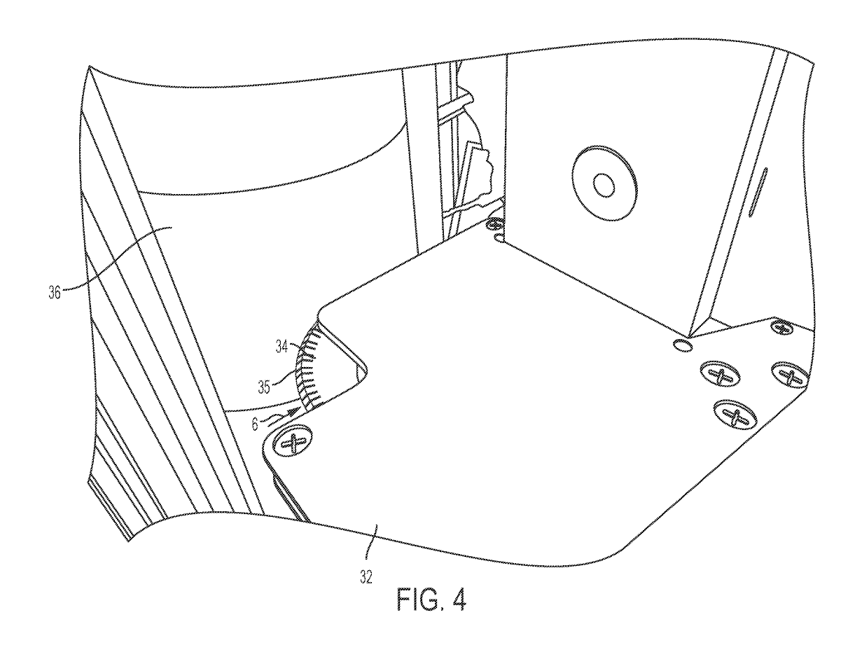

FIG. 4 illustrates a more detailed view of perforator 32 and roller 36. Perforator 32 includes a wheel 34, which includes perforating extrusions 35. These perforating extrusions can be of any suitable shape and configuration. As the length of machine direction unperforated nonwoven product (not shown) is fed through an apparatus in a machine direction 6, it passes between the wheel 34 and the roller 36 such that perforating extrusions 35 penetrate fully or partially through the thickness of the sheet of length of machine direction unperforated nonwoven product (not shown).

For providing perforations in the cross direction 4, a similar perforator to perforator 32 of FIG. 4 can be utilized. The cross direction perforations 10 can be formed with a perforator in the cross direction by passing a length of cross direction unperforated nonwoven product (not shown) past the perforator to delineate the machine direction length of a nonwoven product (such as the nonwoven product of FIG. 1).

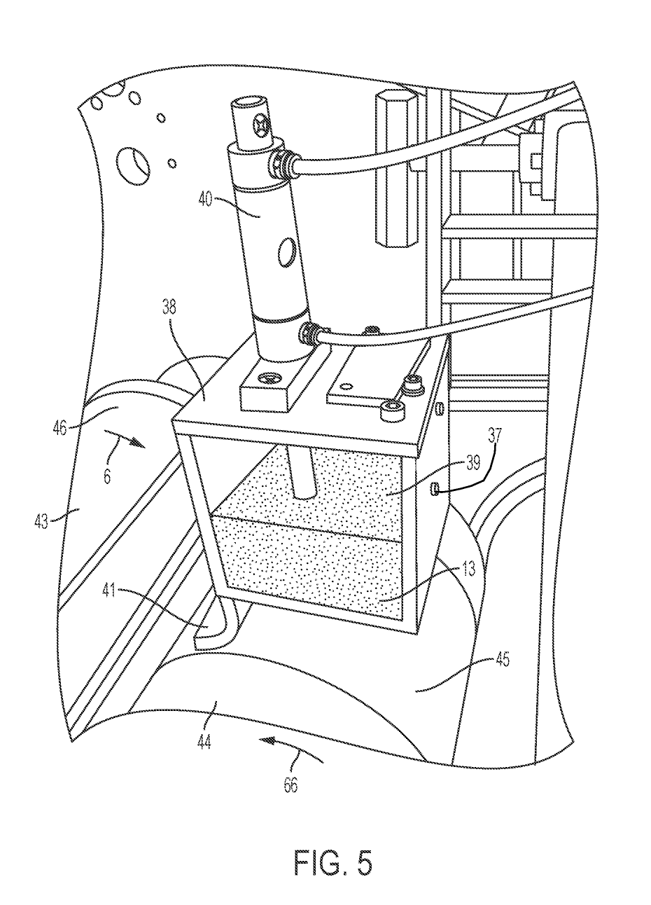

For application of soap material 13, soap material 13 can be applied to a portion of nonwoven material that already is delineated by machine direction perforations (such as 8 of FIG. 1), or soap material 13 can be applied to a portion of nonwoven material that does not include any machine direction perforations. FIG. 5 illustrates one embodiment of a soap applicator 38, which contains a reservoir 39 of soap material 13.

Reservoir 39 contains the soap material 13 at a predetermined level, with additional soap material 13 flowing into reservoir 39 from storage (not shown) as needed. More soap material 13 is caused to flow into reservoir 39 when the level of soap material 13 falls below a level detected by a sensor 37 during use. Once soap material 13 falls below the level of sensor 37, sensor 37 causes a valve to open from storage so that soap material fills to another predetermined level.

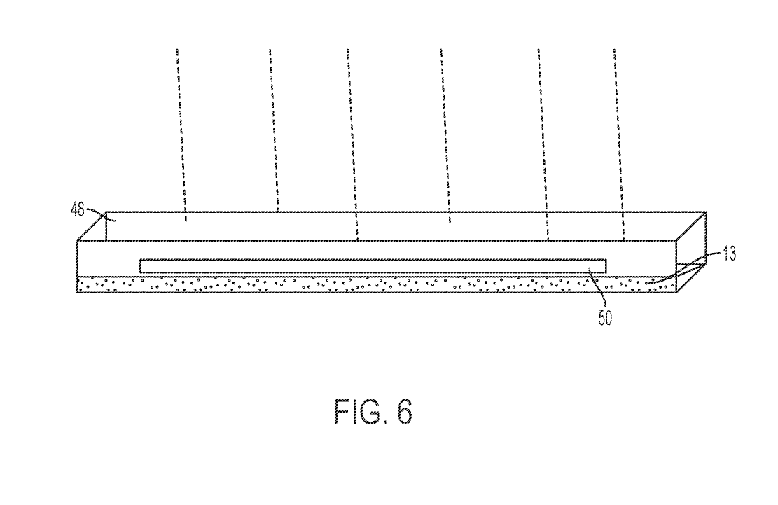

A piston 40 is configured to open and close one or more conduits between reservoir 39 and a fountain reservoir 48 (shown in FIG. 6). During operation of soap applicator 38, piston 40 is actuated to open one or more conduits, allowing soap material 13 to flow from reservoir 39 to the interior of fountain reservoir 48.

As can be seen from FIG. 6, fountain reservoir 48 stores an amount of soap material 13, which exits fountain reservoir 48 through slot 50. Slot 50 can be dimensioned to allow for less or ore flow of soap material 13 out of fountain reservoir 48 and onto a material 41 (as shown in FIG. 5).

Referring again to FIG. 5, material 41 can be any material suitable of transporting soap material 13 from fountain reservoir 48 to a plate 45 of a soap roller 44, such as a felt material. The plate 45 can extend around the circumference of soap roller 44 and can accept an amount of soap material from material 41.

As soap roller 44 rotates in direction 66, and nonwoven roller 46 rotates in machine direction 6, a length of unsoaped nonwoven material 43 comes into contact with plate 45 such that the soap material 13 present on the plate 45 is transferred to the first section (12 of FIG. 1) of the nonwoven material, while the second section (14 of FIG. 1) of the nonwoven material does not have soap material 13 transferred to it. This method and apparatus can be modified to adjust the amount of soap material 13 being transferred to the first section. In one embodiment, the amount of soap material 13 transferred to the first section (12 of FIG. 2) is about two grams of soap material per about ten feet of a length of unsoaped nonwoven material 43 in the machine direction 6.

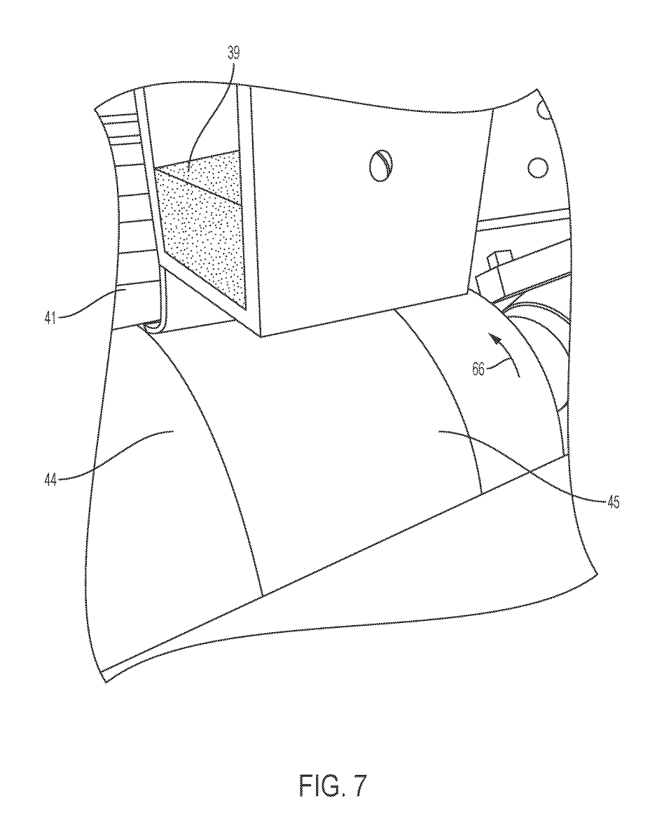

Another view of the process is shown in FIG. 7, which shows plate 45, soap roller 44 that is configured to rotate in direction 66 and material 43 transferring soap material from reservoir 39 onto plate 45. In this embodiment, plate 45 can be any material capable of receiving a soap material and transferring that soap material to a nonwoven roller, such as a rubber or plastic material.

The methods and devices of the present disclosure will be better understood by reference to the following Examples, which are provided as exemplary of the disclosure and not by way of limitation.

### EXAMPLE 1

A user receives a roll 20, as shown in FIG. 2 in their home. To clean a portion of their kitchen counter, the user pulls, along cross direction perforations 10, so they are holding a nonwoven product 1 (as shown in FIG. 1). The user then pulls, along machine direction perforations 8 to separate first section 12 from second section 14.

The user then applies water to first section 12, wipes the portion of the kitchen counter such that soap material 13 is exposed and applied to the kitchen counter, and discards the used first section 12. Lastly, the user wipes the area with second section 14 to remove at least a portion of any residual water and/or soap material 13 from the kitchen counter area, and discards second section 14.

The described embodiments and examples of the present disclosure are intended to be illustrative rather than restrictive, and are not intended to represent every embodiment or example of the present disclosure. While the fundamental novel features of the disclosure as applied to various specific embodiments thereof have been shown, described and pointed out, it will also be understood that various omissions, substitutions and changes in the form and details of the devices illustrated and in their operation, may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiment of the disclosure may be incorporated in any other disclosed or described or suggested form or embodiment as a general matter of design choice. Further, various modifications and variations can be made without departing from the spirit or scope of the disclosure as set forth in the following claims both literally and in equivalents recognized in law.

1. A nonwoven product, the product comprising:
a nonwoven material formed of a fibrous material, the nonwoven material comprising one or more plies, the nonwoven material comprising a first side, a second side, a cross direction and a machine direction, wherein the cross direction is substantially perpendicular to the machine direction, the nonwoven material comprising a number of perforations extending substantially in the cross direction and substantially in the machine direction, wherein the number of perforations extending substantially in the machine direction form a first section of the nonwoven material, the first section comprising a soap material.

2. The product of claim 1, wherein the nonwoven product comprises two plies.

3. The product of claim 1, wherein the soap material comprises
(a) sulfuric acid, C10-16-alkyl ester, sodium salt;
(b) amine oxide, C10-16-alkyldimethyl;
(c) poly(oxy-1,2-ethanediyl),alpha-sulfo-omega-hydroxy-C10-16-alkyl ether, sodium salt; and
(d) water.

4. The product of claim 3, wherein the soap material comprises
(a) about 15% to about 20% by volume of sulfuric acid, C10-16-alkyl ester, sodium salt;
(b) about 5% to about 10% by volume amine oxide, C10-16-alkyldimethyl;
(c) about 5% to about 10% by volume poly(oxy-1,2-ethanediyl),alpha-sulfo-omega-hydroxy-C10-16-alkyl ether, sodium salt; and
(d) a remaining volume of water.

5. A method of producing a nonwoven product comprising the steps of:
applying a soap material to a first section of a nonwoven material, the nonwoven material formed of a fibrous material, the nonwoven material comprising one or more plies, the nonwoven material comprising a first side, a second side, a cross direction and a machine direction, wherein the cross direction is substantially perpendicular to the machine direction.

6. The method of claim 5, further comprising the step of perforating the nonwoven product in the cross direction.

7. The method of claim 5, further comprising the step of perforating the nonwoven product in the machine direction.

8. The method of claim 7, wherein the perforations in the machine direction form the first section of the nonwoven material.

9. The method of claim 5, wherein the nonwoven product comprises two plies.

10. The method of claim 5, wherein the soap material comprises
(a) sulfuric acid, C10-16-alkyl ester, sodium salt;
(b) amine oxide, C10-16-alkyldimethyl;
(c) poly(oxy-1,2-ethanediyl),alpha-sulfo-omega-hydroxy-C10-16-alkyl ether, sodium salt; and
(d) water.

11. The method of claim 10, wherein the soap material comprises
(a) about 15% to about 20% by volume of sulfuric acid, C10-16-alkyl ester, sodium salt;
(b) about 5% to about 10% by volume amine oxide, C10-16-alkyldimethyl;
(c) about 5% to about 10% by volume poly(oxy-1,2-ethanediyl),alpha-sulfo-omega-hydroxy-C10-16-alkyl ether, sodium salt; and
(d) a remaining volume of water.
